(19) United States
(12) Patent Application Publication
(10) Pub. No.: US 2022/0329697 A1
(43) Pub. Date: Oct. 13, 2022

(54) SYSTEMS AND METHODS FOR DETECTION OF TOLL-FREE ROUTING INTERRUPTIONS AND CORRECTION OF SAME

(71) Applicant: Inteliquent, Inc., Chicago, IL (US)

(72) Inventors: Nicholas W. Reifschneider, Westminster, CO (US); Brett A. Scorza, Downers Grove, IL (US); Mark Rubin, Buffalo Grove, IL (US)

(21) Appl. No.: 17/654,953

(22) Filed: Mar. 15, 2022

Related U.S. Application Data
(60) Provisional application No. 63/174,311, filed on Apr. 13, 2021.

(51) Int. Cl. H04M 7/12

(52) U.S. Cl. CPC H04M 7/128

(57) ABSTRACT

Systems and methods for determining if a service interruption is associated with a placed toll-free call and if so, routing future toll-free calls to an alternative carrier route to ensure that subsequently placed toll-free calls are connected with the toll-free subscriber.

### PRIORITY CLAIM

This application claims the benefit of and priority to U.S. Provisional Patent Application No. 63/174,311, filed on Apr. 13, 2021, the entire contents of which is incorporated by reference herein.

### TECHNICAL FIELD

This disclosure relates to the field of telecommunications, and more particularly, to the detection of toll-free routing interruptions and the correction of same.

### BACKGROUND

Telecommunication carriers, such as interexchange carriers and local exchange carriers, transmit communications data, such as voice traffic, through telecommunication networks. Certain telecommunication networks provide toll-free communications in which a called toll-free subscriber pays for all long-distance telephone calls made to the toll-free telephone number associated with that toll-free subscriber. Businesses increasingly use toll-free telephone numbers for providing callers with a relatively convenient and cost-free way of communicating with them and their various departments_{;} such as customer service and technical support representatives,

All possible toll-free telephone numbers are maintained in a centralized service management system database (i.e., the “Somos SMS database”). This service management system database includes information on all toll-free telephone numbers currently in use by toll-free subscribers as well as, for each toll-free telephone number in use, carrier routing instructions to the toll-free subscriber or the long distance carrier associated with that toll-free telephone number. To maintain the integrity of this database, only certain entities known as Responsible Organizations (“RespOrgs”) are tasked with managing and administering toll free numbers through the Somos SMS database. Accordingly, to realize the benefits of having a toll-free telephone number, a toll-free subscriber must either authorize a RespOrg or otherwise operate as their own RespOrg in managing information stored about their toll-free telephone number.

In operation, when a caller calls a toll-free telephone number, the originating local carrier does not simply pass the call to the caller's pre-subscribed interexchange carrier (as it would for a non-toll free call) but rather queries the Somos SMS database for the specific carrier routing instructions to the toll-free subscriber. The database query produces a carrier identification code (“CIC”) which tells the local exchange carrier to route the call to an interexchange carrier associated with the produced CIC. The originating local carrier then uses its own or an intermediate carrier's transport and switching facilities to route the call to the interexchange carrier (which then becomes responsible for routing the toll-free call to the toll-free subscriber by routing the call to the nearest local exchange carrier of the toll-free subscriber to connect the toll-free call). Accordingly, when a caller calls a toll-free telephone number, one or more telecommunication carriers operate with one or more computing systems that maintain the Somos SMS database to obtain the carrier routing instructions to enable such telecommunication carriers to connect the caller to the called toll-free telephone number.

However, due to the static nature of carrier routing instructions maintained in the Somos SMS database, service outages are particularly problematic for connecting toll-free telephone calls. That is, for certain toll-free subscribers, a telecommunication network service outage at one or more points along the path established by the routing instructions maintained in the Somos SMS database will result in the inability to connect toll-free calls to that toll-free subscriber using the maintained routing instructions. Such inability to connect toll-free calls may result in angry calling parties, lost customers and/or lost revenue.

Moreover, since a toll-free subscriber has limited to no visibility or control regarding the origination of toll-free calls, the toll-free subscriber has limited to no recourse to proactively attempt to cure any defects with such toll-free calls not being connected. In other words, in certain instances, only by receiving non-toll-free calls from customers complaining about the inoperability of the toll-free subscriber's toll-free telephone number does the toll-free subscriber even become aware of such problems. And even in this scenario, identifying the precise point of call failure may be difficult, time consuming, or unachievable. Such a lack of visibility and control may also result in angry calling parties, lost customers and/or lost revenue.

Accordingly, a need exists to identify how service outages affect the carrier routing instructions maintained in the centralized service management system database and route subsequent toll-free telephone calls to the appropriate toll-free subscriber in view of such service outages.

The invention(s) described herein is/are directed, but not limited, to addressing these and other issues associated with existing systems and methods. Other aspects and benefits not related to these issues are contemplated as well.

### SUMMARY

Systems and associated methods are provided for determining if a service interruption is associated with a placed toll-free call and if so, routing future toll-free calls to an alternative carrier route to ensure that subsequently placed toll-free calls are connected with the toll-free subscriber.

According to a particular and non-limiting aspect, the system includes a processor and a memory device that stores a plurality of instructions. When executed by the processor, the instructions cause the processor to monitor for any predicted service interruptions associated with a primary carrier route of a toll-free telephone number. Additionally, when executed by the processor responsive to a determination of a predicted service interruption associated with the primary carrier route of the toll-free telephone number, the instructions determine an alternative carrier route of the toll-free telephone number, and communicate data to a service management system database to replace the primary carrier route of the toll-free telephone number with the determined alternative carrier route of the toll-free telephone number for at least one call.

According to another particular and non-limiting aspect, a method of the present disclosure includes monitoring, by a processor, for any predicted service interruptions associated with a primary carrier route of a toll-free telephone number. Responsive to a determination of a predicted service interruption associated with the primary carrier route of the toll-free telephone number, the method includes determining, by the processor, an alternative carrier route of the toll-free telephone number, and communicating data to a service management system database to replace the primary carrier route of the toll-free telephone number with the determined alternative carrier route of the toll-free telephone number for at least one call.

These and other aspects will become readily apparent from the written specification, drawings, and claims provided herein.

### BRIEF DESCRIPTION OF DRAWINGS

FIG. 1 is a schematic diagram illustrating an exemplary embodiment of a system in accordance with one or more aspects described herein.

FIG. 2 is a schematic diagram illustrating an exemplary workflow to route toll-free telephone calls in accordance with one or more aspects described herein.

FIG. 3 is a schematic diagram of an exemplary computing device capable of supporting and facilitating one or more aspects described herein.

### DETAILED DESCRIPTION OF EXEMPLARY EMBODIMENTS

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention(s) is/are intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates the didactic purpose of the specification. Additionally, the drawings set forth herein are not necessarily drawn to scale, and in some instances proportions may have been exaggerated to more clearly depict certain features. Such labeling and drawing practices do not necessarily implicate an underlying substantive purpose. Furthermore, one or more drawings herein may be of a purely functional schematic nature, or a combination of a functional and structural/hardware schematic nature, intended to disclose and teach functional aspects of the subject matter without necessarily limiting the disclosure to any specific structure/hardware. As stated above, the present specification is intended to be taken as a whole and interpreted in accordance with the principles of the invention(s) as taught herein and understood to one of ordinary skill in the art.

With respect to the exemplary systems, components and architecture described and illustrated herein, it should also be understood that the invention(s) may be embodied by, or employed in, numerous configurations and components, including one or more system, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system. Furthermore, although one or more systems and associated servers, gateways, registries or databases may be described, all methods, systems, and articles of manufacture consistent with known architecture for these components are intended to be encompassed. For example, a processor may be implemented as part of one or more components as a microprocessor, microcontroller, application specific integrated circuit (ASIC), discrete logic, or a combination of other type of circuits or logic. Similarly, memories as part of one or more of these components may be DRAM, SRAM, Flash or any other type of memory. Flags, data, databases, tables, and other data structures may be separately stored and managed, may be incorporated into a single memory or database, may be distributed, or may be logically and physically organized in many different ways. Software programs, which may be described in terms of one or more code segments, may be parts of a single program, separate programs, or distributed across several memories and processors. The methods and functionality described herein may be implemented via hardware, software, and/or firmware, and processed by one or more processor-based systems, components or devices. Such methods and functionality may be described as a module or engine with the understanding that its implementation is not limited to any particular hardware, software, firmware, or device configuration, but rather encompassing all implementations/embodiments within the skill of one of ordinary skill in the art. Systems may be implemented in hardware, software, or a combination of hardware and software in one processing system or distributed across multiple processing systems. Accordingly, the invention(s) should not be construed as limited by the exemplary embodiments described herein or any of the associated didactic schematics.

In various embodiments, the systems and associated methods of the present disclosure determine if a service interruption is associated with a primary carrier route employed for making a toll-free call. In certain embodiments, the systems and associated methods determine if a service interruption is associated with a primary carrier route employed for making a toll-free call based on analyzing current toll-free call metrics relative to historical toll-free call metrics and/or anticipated toll-free call metrics. In these embodiments, if the system determines that the difference between current toll-free call metrics and historical toll-free call metrics and/or anticipated toll-free call metrics is outside a designated range, the system determines that a service interruption event has occurred in association with a primary carrier route employed for making a toll-free call. For example, the predictive algorithm employed by the system analyzes toll-free call volume from a source, such as the quantity of toll-free calls processed by a local exchange carrier of the primary carrier route, relative to historical toll-free call volume from that source, wherein if the difference between current toll-free call volume from the source and historical toll-free call volume from that source exceeds a designated difference, the system determines that an interruption event has occurred in association with that source. As illustrated by this example, in certain embodiments, the system utilizes relative toll-free call metrics to predict toll-free routing interruptions prior to otherwise being notified of such interruptions. In such embodiments, the system algorithmically correlates such toll-free call metrics (e.g., call patterns and test calls) to proactively identify that there is a fault and cure the fault before a trouble ticket even occurs.

In various embodiments, responsive to a determination of a service interruption associated with a primary carrier route employed for making a toll-free call, the systems and methods of the present disclosure additionally or alternatively routes future toll-free calls to a new carrier route (with or without utilizing one or more specific networks) to ensure that such subsequently placed toll-free calls are connected with the toll-free subscriber. In certain embodiments, the systems and methods of the present disclosure route future toll-free calls to a new carrier route (i.e., an alternative carrier route) by analyzing the original carrier route for making the toll-free call and determining a new carrier route that does not include any paths known to include any known or predicted service interruptions. For example, following the system determining that an service interruption event has occurred in association with a local exchange carrier of a primary carrier route for making a toll-free call, the algorithm employed by the system determines an alternative carrier route that avoids the compromised local exchange carrier in connecting future toll-free calls with the toll-free subscriber.

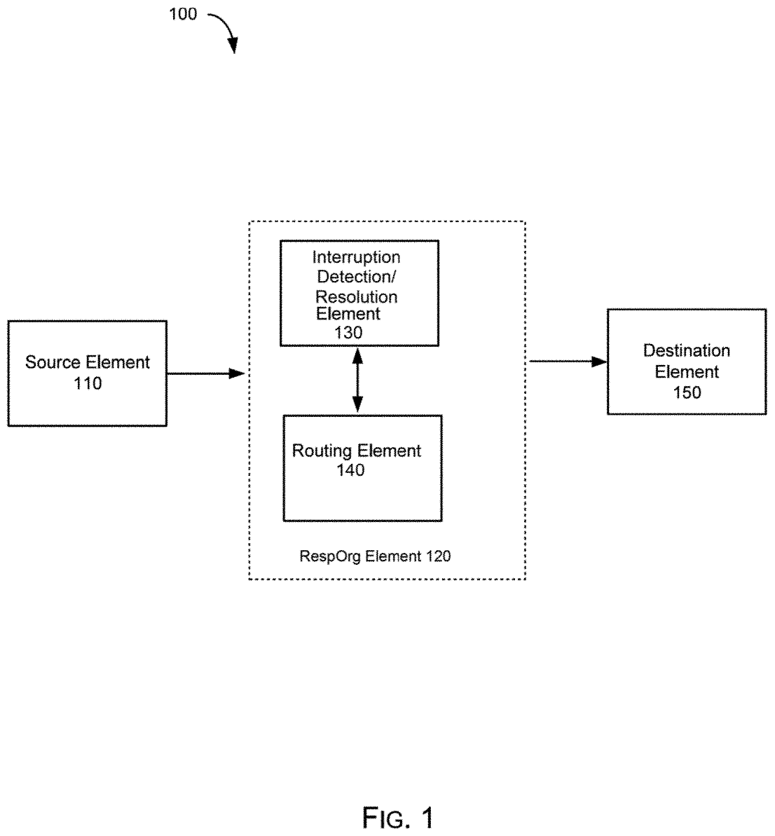

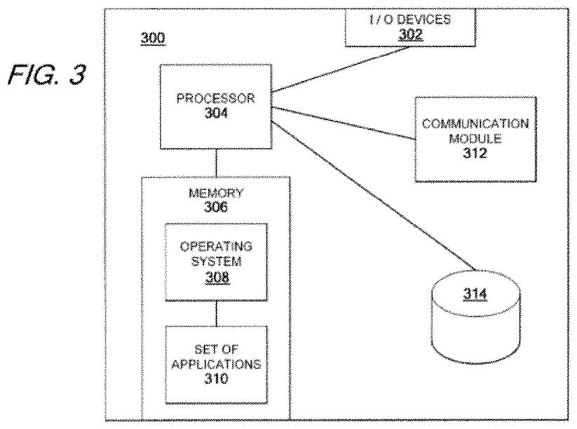

FIG. 1 illustrates an exemplary, non-limiting embodiment of a system 100 according to embodiments of the present disclosure. In this embodiment, system 100 includes a toll-free call source element 110, a RespOrg element 120 (including an interruption detection/resolution element 130 and a routing element 140) and a destination element 150. It should be appreciated that one or more of the elements of system 100 may part of a computing system or computing device, such as the computing device described with respect to FIG. 3.

In certain embodiments, toll-free call source element 110 includes a source that generates, originates, or otherwise creates one or more toll-free calls to be connected with destination element 150 via one or more network paths determined by routing element 140 based on zero, one or more determinations made by interruption detection/resolution element 130. For example, a toll-free call source element includes the point of origin from which a toll-free call is made by an end user via dialing a toll-free telephone number associated with a destination element, such as a toll-free subscriber. In this example, responsive to the end user dialing the toll-free telephone number and a determination, such as by interruption detection/resolution element 130, of a service outage, one or more components of the routing element 140 determines one or more steps in how to route subsequent toll-free calls to the destination element, such as which interexchange carrier to route the data associated with subsequent toll-free calls to such that such subsequent toll-free calls reach the destination element 150.

Specifically, following the placement of a toll-free telephone call in association with a toll-free call source element 110 and absent any detected (or other predicted) service outages along the primary carrier route maintained in the Somos SMS database for making the toll-free call from the toll-free call source element 110, the routing element 140 notifies the local exchange carrier associated with the toll-free call source element 110 of the primary carrier route to employ to route the toll-free call. In certain such embodiments, when routing a toll-free telephone call without any known service disruptions, the routing element 140 determines the primary carrier route maintained in the Somos SMS database via accessing a pre-existing routing table that contains routing decisions for each routing parameter based on information associated with the toll-free telephone call. Such a pre-existing routing table includes zero, one or more static routing parameters associated with the toll-free call source element, and zero, one or more static routing parameters associated with the destination element.

On the other hand, following the placement of a toll-free telephone call in association with a toll-free call source element 110 and responsive to the routing element 140 operating with the interruption detection/resolution element 130 to determine that one or more service outages have been detected (or otherwise predicted) along the primary carrier route maintained in the Somos SMS database for making the toll-free call from the toll-free call source element 110 to the destination element 150, the routing demerit 140 determines an alternative carrier route and updates the Somos SMS database of the determined alternative carrier route for making subsequent toll-free calls from the toll-free call source element 110. In certain such embodiments, when determining a new route for future toll-free telephone calls in view of one or more determined service disruptions, the routing dement 140 determines an alternative carrier route based on zero, one or more static routing parameters associated with the toll-free call source element, zero, one or more static routing parameters that are associated with the destination element and zero, one or more routing parameters that are determined based on the determined service disruptions.

More specifically, prior to determining whether or not to employ an alternative carrier route for certain toll-free calls carried over certain carrier networks, the system determines if any carrier related service issues prevent the utilization of the primary carrier route for such toll-free calls. Such carrier related service issues include bandwidth issues, connection issues, routing issues, switching issues. network component issues, geographic issues, or any other suitable issues that degrades service of such toll-free cads or prevents such toll-free calls from being connected.

In certain embodiments, the system of the present disclosure monitors for any occurrence of any service interruptions related to one or more telecommunication carriers associated with one or more primary carrier routes. In these embodiments, the system periodically monitors for any occurrence of any service interruptions related to any telecommunication carrier by determining, at designated intervals, whether the amount of data being transmitted by that telecommunication carrier complies with an anticipated amount of data being transmitted by that telecommunication carrier. In such embodiments, the anticipated amount of data being transmitted by that telecommunication carrier is based on historical amounts of data for a designated interval. For example, the system compares the amount of toll-free calls currently being handled by a telecommunication carrier on a. Friday afternoon against the average amount of toll-free calls handled by that telecommunication carder on an average Friday afternoon. If the system determines that the amount of data being transmitted by that telecommunication carrier fails to comply with the anticipated amount of data being transmitted by that telecommunication carrier, the system determines that a service interruption has occurred in relation to that telecommunication carrier and any primary carrier route utilizing that telecommunication carrier may need to be replaced with another carrier route until the service interruption is resolved.

It should be appreciated that in these embodiments, the relationship between one or more components of the system and a telecommunication carrier provides different degrees of visibility to whether or not a service interruption has occurred. For example, a service interruption for a toll-free call being carried on a network of a telecommunication carrier associated with the system may be automatically determined by one or more components of the system while a service interruption for a toll-free call being carried on a network of a telecommunication carrier independent of the system may be determined by comparing amounts of data transmitted relative to anticipated amount of data transmitted. As illustrated by this example, different levels of detectability of service interruptions exist for different networks based on whether such a network is associated with the system of the present disclosure or a third-party network.

In certain embodiments, the system of the present disclosure additionally or alternatively monitors for any occurrence of any service interruptions related to one or more network components associated with one or more primary carrier routes. In these embodiments, the system periodically monitors for any occurrence of any service interruptions related to any network components by determining, at designated intervals, whether the amount of data being transmitted across that network component complies with an anticipated amount of data being transmitted across that network component. In such embodiments, the anticipated amount of data being transmitted across that network component is based on historical amounts of data for a designated interval. For example, the system analyzes the amount of data being handled by a particular routing switch relative to historic amounts of data being handled by that routing switch and predicts, based on the analysis, whether or not any issues are present with the operation of that routing switch. if the system determines that the amount of data being transmitted across that network component fails to comply with the anticipated amount of data being transmitted across that network component, the system determines that a service interruption has occurred in relation to that network component and any primary carrier route utilizing that network component may need to be replaced with another carrier route until the service interruption is resolved.

In certain embodiments, the system of the present disclosure additionally or alternatively monitors for any occurrence of any service interruptions related to one or more markets (e. geographic regions or specific locations) associated with one or more primary carrier routes. in these embodiments, the system periodically monitors for any occurrence of any service interruptions related to any markets by determining, at designated intervals, whether the amount of data being transmitted through that market complies with an anticipated amount of data being transmitted through that market. in such embodiments, the anticipated amount of data being transmitted through that market is based on historical amounts of data for a designated interval. If the system determines that the amount of data being transmitted through that market fails to comply with the anticipated amount of data being transmitted through that market, the system determines that a service interruption has occurred in relation to that market and any primary carrier route utilizing that market may need to be replaced with another carrier route until the service interruption is resolved.

In certain embodiments, the system of the present disclosure additionally or alternatively monitors for any occurrence of any service interruptions based on the data being transmitted along one or more primary carrier routes. In these embodiments, the system periodically monitors for any occurrence of any service interruptions by determining, at designated intervals, whether any characteristics or attributes of the data being transmitted along one or more primary carrier routes complies with the anticipated characteristics or attributes of such data. In such embodiments, the anticipated characteristics or attributes of such data is based on historical characteristics or attributes of such data for a designated interval. if the system determines that the characteristics or attributes of the data being transmitted along one or more primary carrier routes fails to comply with the anticipated characteristics or attributes of such data, the system determines that a service interruption has occurred in relation to that primary carrier route and that primary carrier route may need to be replaced with another carrier route until the service interruption is resolved.

In certain embodiments, the system of the present disclosure additionally or alternatively monitors for any occurrence of any service interruptions related to any notifications received regarding any toll-free call failures. In certain such embodiments, the system monitors for any occurrence of any service interruptions based on any determined issues reported by any toll-free. subscribers. In certain other embodiments, the system monitors for any occurrence of any service interruptions based on any determined issues self-reported by any carriers. If the system determines based on these reported issues (and any corresponding analyses by the system to confirm the accuracy of these reported issues) that a service interruption has occurred, the system determines that a primary carrier route may need to be replaced with another carrier route until the service interruption is resolved.

In certain embodiments, the system of the present disclosure additionally or alternatively monitors for any occurrence of any service interruptions related to any modifications of the Somos SMS database. In certain such embodiments, the system monitors for any occurrence of any service interruptions based on any modifications of the Somos SMS database previously made by the system in association with the primary carrier route for any modifications of another primary carrier route made by the system or by another system).

If the system determines that one or more carrier related service issues prevent the utilization of the primary carrier route for a toll-free call, the system determines an alternative carrier route for future toll-free cabs. That is, following the determination that the primary carrier route maintained in the Somos SMS database to connect a toll-free call from a toll-free call source to a toll-free subscriber is temporarily or permanently compromised due to one or more service issues, the system utilizes data associated with such service issues to determine an alternative carrier route, for calls made after the change in the Somos SMS database, that avoids these service issues.

Accordingly, since a toll-free subscriber has limited to no visibility or control regarding the origination of toll-free calls, the system of the present disclosure employs one or more predictive algorithms to detect any service interruptions based on one or more system conditions which the toll-free subscriber has visibility to. That is, the system of the present disclosure determines any discrepancies between anticipated toll-free call data and actual toll-free call data (and/or other toll-free call anomalies) and uses such determinations to provide recourse to proactively attempt to cure any defects with toll-free calls not being connected (which the system would otherwise not become aware of until toll-free subscribers begin voicing complaints).

In certain embodiments, the alternative carrier route includes routing data associated with a toll-free call to an alternative carrier to connect the toll-free subscriber and subsequent toll-free callers. In certain other embodiments, the alternative carrier route includes routing data associated with a toll-free call to an alternative designated network to connect the toll-free subscriber and subsequent toll-free callers. In certain other embodiments, the alternative carrier route includes routing data associated with a toll-free call to one or more alternative carriers and one or more designated networks to connect the toll-free subscriber and subsequent toll-free callers. In certain embodiments, the system utilizes a predetermined alternative carrier route that bypasses the service issues associated with the primary carrier route. In certain other embodiments, the system determines an alternative carrier route by analyzing the different routing options still available (after accounting for any compromised routing options) and selecting a routing options that connects future toll-free call sources to the toll-free subscriber (with or without utilizing one or more networks identified by the system of the present disclosure) while bypassing the service issues associated with the primary carrier route.

In certain embodiments, following the determination of an alternative carrier route, the system communicates data to the Somos SMS database such that, until the service issues are resolved, future toll-free calls that would have otherwise used the primary carrier route with the determined service issues instead use the alternative carrier route (with or without utilizing one or more networks identified by the system of the present disclosure). For example, following a caller dialing a toll-free telephone number, the originating carrier queries the Somos SMS database for the specific carrier routing instructions to the toll-free subscriber (or a carrier associated with the toll-free subscriber). In this example, rather than the Somos SMS database query producing the pre-service interruption CIC associated with the pre-service interruption carrier route which informs the local exchange carrier to route the call to the toll-free subscriber via a pre-service interruption path (which, in this case, would result in a failed call due to the interruption in service), the Somos SMS database query produces a post-service interruption CIC associated with a post-service interruption carrier route which informs the local exchange carrier to route the call to the toll-free subscriber (or a carrier associated with the toll-free subscriber) via a post-service interruption path which may or may not include utilizing one or more networks of the system of the present disclosure. As illustrated by this example, since the Somos SMS database maintains a single CIC associated with a single carrier route, whichever CIC associated with whichever carrier route is currently included in the Somos SMS database is produced from the Somos SMS database query.

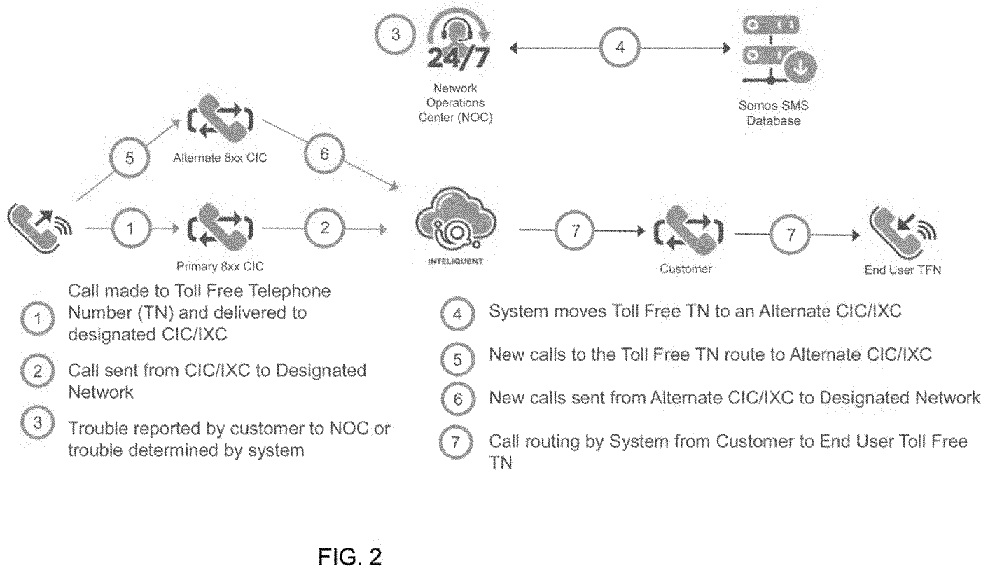

Accordingly, as seen in FIG. 2, following a toll-free call made to a toll-free number, the originating local carrier communicates data associated with the toll-free call to a designated CIC/IXC, associated with a primary carrier route (i.e., Primary 8xx CIC) for that toll-free number (e.g., steps 1 and 2 of FIG. 2). As also seen in FIG. 2, responsive to a detection of a service interruption, such as a predicted service interruption (not shown) or a reported service interruption (e.g., step 3 of FIG. 2), the system determines a new carrier route (i.e. Alternate 8xx CIC) for a newly placed toll-free call (e.g. steps 5 and 6 of FIG. 2) and updates the Somos SMS database of this new carrier route for the toll-free number (e.g., step 4 of FIG. 2) to ensure that future toll-free calls that would otherwise use the primary carrier route are routed to that new carrier route. Following such determinations and updates, the system operates to route future toll-free calls made to that toll-free number to the new carrier route and then to the network identified by the system for delivery until a resolution of the detected service interruption (e.g., step 7 of FIG. 2).

In addition to modifying the routing instructions from a toll-free call source to a toll-free subscriber responsive to the determination of one or more service interruptions along the primary carrier route, the system determines if any carrier related service issues which prevented the utilization of the primary carrier route for such toll-free calls have been resolved. if the system determines (or is otherwise notified) that such service issues which caused the employment of the alternative carrier route have been resolved, the system updates the Somos SMS database with the information associated with the primary carrier route. That is, following the determination that the use of the alternative carrier route is no longer necessary, the system replaces the alternative CIC with the original CIC within the Somos SMS database for future toll-free calls.

FIG. 3 is a block diagram of an exemplary computing device 300 that may be employed to accomplish any of the above-described processes. The computing device 300 houses executable software used to facilitate the systems and methods as described herein. One or more instances of the computing device 300 may be utilized to implement any, some, or all of the components interacting with the system 100. The computing device 300 includes a memory 306 that can include a computer readable medium for implementing the systems and methods as described herein, and for implementing particular embodiments. The computing device 300 also contains executable software, some of which may or may not be unique to the systems and methods.

In some embodiments, the systems and methods can be implemented in software, as an executable program, and can be executed by one or more special or general purpose digital computer(s), such as a mainframe computer, a personal computer (desktop, laptop or otherwise), personal digital assistant, or other handheld computing device. Therefore, the computing device 300 may be representative of any computer in which the systems and methods reside or partially reside. It should also be noted that, in some embodiments, the computing device 300 may be running in a virtualization on hardware architecture, such as, for example, through Amazon® Web Services.

Generally, in terms of hardware architecture as shown in FIG. 3, the computing device 300 includes a processor 304, the memory 306, and one or more input and/or output (I/O) devices 302 (or peripherals) that are communicatively coupled via an interface such as one or more buses or other wired or wireless connections, as is known in the art. The processor 304 can be a hardware device for executing software, particularly software stored in the memory 306. Further, the processor 304 can interface with a database 314 that can store various amounts and types of data. For example, the database can store any of the types of communications data or resolved communications data described herein. The processor 304 can be any custom made or commercially available processor, such as, for example, a Core series or vPro processor made by Intel Corporation, or a Phenom, Athlon or Sempron processor made by Advanced Micro Devices, Inc. In the case where the computing device 300 is a server, the processor 304 may be, for example, a Xeon or Itanium processor from Intel, or an Opteron-series processor from Advanced Micro Devices, Inc. The processor 304 may also represent multiple parallel or distributed processors working in unison.

The memory 306 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). Further, the memory 306 may incorporate electronic, magnetic, optical, and/or other types of storage media and can have a distributed architecture where various components are situated remote from one another, but are still accessed by the processor 304. These other components may reside on devices located elsewhere on a network or in a cloud arrangement.

The software in the memory 306 may include one or more separate programs or applications 310. The separate applications 310 comprise ordered listings of executable instructions for implementing logical functions, such as functions relating to predicting service interruptions as discussed herein. In the example of FIG. 2, the software in the memory 306 may include a suitable operating system (O/S) 308. Examples of some operating systems 308 are Windows operating systems available from Microsoft Corporation, Mac OS X available from Apple Computer, Inc., a Unix operating system from AT&T, or a Unix-derivative such as BSD or Linux. The type of the operating system 308 will depend on the type of the computing device 300. The operating system 308 can control the execution of other computer programs, and can provide scheduling, input-output control, file and data management, memory management, and communication control and related services.

If the computing device 300 is an IBM PC compatible computer or the like, the software in the memory 306 may further include a basic input output system (BIOS). The BIOS is a set of essential software routines that initialize and test hardware at startup, start the operating system 308, and support the transfer of data among the hardware devices. The BIOS is stored in ROM so that the BIOS can be executed when the computing device 300 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Lua, and Go. Components and entities as discussed herein may also be written in a proprietary language developed to interact with these known languages.

The I/O device(s) 302 may include input devices such as a keyboard, a mouse, a scanner, a microphone, a touch screen, a bar code reader, or an infra-red reader. It may also include output devices such as a printer, a video display, an audio speaker or headphone port or a projector. The I/O device(s) 302 may also comprise devices that communicate with inputs or outputs, such as a short-range transceiver (RFID, Bluetooth, etc.), a telephonic interface, a cellular communication port, a router, or other types of network communication equipment. The I/O devices 302 may be internal to the computing device 300, or may be external and connected wirelessly or via connection cable, such as through a universal serial bus port.

When the computing device 300 is in operation, the processor 304 is configured to execute software stored within the memory 306, to communicate data to and from the memory 306, and to generally control operations of the computing device 300 pursuant to the software. The operating system 308, in whole or in part, may be read by the processor 304, buffered within the processor 304, and then executed.

In the context of this document, a “computer-readable medium” may be any means that can store, communicate, propagate, or transport data objects for use by or in connection with the systems and methods as described herein. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The systems and methods can be embodied in any type of computer-readable medium for use by or in connection with an instruction execution system or apparatus, such as a computer.

For purposes of connecting to other computing devices, the computing device 300 is equipped with network communication equipment and circuitry, including a communication module 312. In embodiments, the network communication equipment includes a network card such as an Ethernet card, or a wireless connection card. In a preferred network environment, each of the plurality of computing devices 300 on the network is configured to use the Internet protocol suite (TCP/IP) to communicate with one another. It will be understood, however, that a variety of network protocols could also be employed, such as IEEE 802.11 Wi-Fi, address resolution protocol

ARP, spanning-tree protocol STP, or fiber-distributed data interface FDDI. It will also be understood that while a preferred embodiment of the invention is for each computing device 300 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

While one or more specific embodiments have been illustrated and described in connection with the invention(s), it is understood that the invention(s) should not be limited to any single embodiment, but rather construed in breadth and scope in accordance with recitation of the appended claims. As such, various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope.

What is claimed is:

1. A system comprising:
a processor; and
a memory device that stores a plurality of instructions that, when executed by the processor, cause the processor to:
monitor for any predicted service interruptions associated with a primary carrier route of a toll-free telephone number, and
responsive to a determination of a predicted service interruption associated with the primary carrier route of the toll-free telephone number:
determine an alternative carrier route of the toll-free telephone number, and
communicate data to a service management system database to replace the primary carrier route of the toll-free telephone number with the determined alternative carrier route of the toll-free telephone number for at least one call.

2. The system of claim 1, wherein the determination of the predicted service interruption associated with the primary carrier route of the toll-free telephone number is based on an amount of data transmitted by a telecommunication carrier associated with the primary carrier route compared to an amount of data expected to be transmitted by the telecommunication carrier.

3. The system of claim 1, wherein the determination of the predicted service interruption associated with the primary carrier route of the toll-free telephone number is based on an amount of data transmitted across a network component associated with the primary carrier route compared to an amount of data expected to be transmitted across the network component.

4. The system of claim 1, wherein the determination of the predicted service interruption associated with the primary carrier route of the toll-free telephone number is based on an amount of data transmitted through a geographic region associated with the primary carrier route compared to an amount of data expected to be transmitted through the geographic region.

5. The system of claim 1, wherein the determination of the predicted service interruption associated with the primary carrier route of the toll-free telephone number is based on an attribute of data transmitted along the primary carrier route compared to an expected attribute of data to be transmitted along the primary carrier route.

6. The system of claim 1, wherein the memory device stores a plurality of further instructions that, when executed by the processor responsive to a determination that the predicted service interruption associated with the primary carrier route of the toll-free telephone number has been resolved, cause the processor to communicate data to the service management system database to replace the determined alternative carrier route of the toll-free telephone number with the primary carrier route of the toll-free telephone number.

7. The system of claim 1, wherein the memory device stores a plurality of further instructions that, when executed by the processor responsive to the determination of the predicted service interruption associated with the primary carrier route of the toll-free telephone number, cause the processor to determine the alternative carrier route of the toll-free telephone number based on at least one of: a static routing parameter associated with a call source element, a static routing parameter associated with a destination element, and a routing parameter associated with the predicted service interruption.

8. A system comprising:
a processor; and
a memory device that stores a plurality of instructions that, when executed by the processor, cause the processor to:
monitor for any predicted service interruptions associated with a primary carrier route of a toll-free telephone number, and
responsive to a determination of a predicted service interruption associated with the primary carrier route of the toll-free telephone number, communicate notification data associated with the predicted service interruption to a telecommunication carrier.

9. The system of claim 8, wherein the determination of the predicted service interruption associated with the primary carrier route of the toll-free telephone number is based on an amount of data transmitted by a telecommunication carrier associated with the primary carrier route compared to an amount of data expected to be transmitted by the telecommunication carrier.

10. The system of claim 8, wherein the determination of the predicted service interruption associated with the primary carrier route of the toll-free telephone number is based on an amount of data transmitted across a network component associated with the primary carrier route compared to an amount of data expected to be transmitted across the network component.

11. The system of claim 8, wherein the determination of the predicted service interruption associated with the primary carrier route of the toll-free telephone number is based on an amount of data transmitted through a geographic region associated with the primary carrier route compared to an amount of data expected to be transmitted through the geographic region.

12. The system of claim 8, wherein the determination of the predicted service interruption associated with the primary carrier route of the toll-free telephone number is based on an attribute of data transmitted along the primary carrier route compared to an expected attribute of data to be transmitted along the primary carrier route.

13. The system of claim 8, wherein the telecommunication carrier is associated with the primary carrier route of the toll-free telephone number.

14. A method of operating a system, the method comprising:
monitoring, by a processor, for any predicted service interruptions associated with a primary carrier route of a toll-free telephone number, and
responsive to a determination of a predicted service interruption associated with the primary carrier route of the toll-free telephone number:
determining, by the processor, an alternative carrier route of the toll-free telephone number, and
communicating data to a service management system database to replace the primary carrier route of the toll-free telephone number with the determined alternative carrier route of the toll-free telephone number for at least one call.

15. The method of claim 14, wherein the determination of the predicted service interruption associated with the primary carrier route of the toll-free telephone number is based on an amount of data transmitted by a telecommunication carrier associated with the primary carrier route compared to an amount of data expected to be transmitted by the telecommunication carrier.

16. The method of claim 14, wherein the determination of the predicted service interruption associated with the primary carrier route of the toll-free telephone number is based on an amount of data transmitted across a network component associated with the primary carrier route compared to an amount of data expected to be transmitted across the network component.

17. The method of claim 14, wherein the determination of the predicted service interruption associated with the primary carrier route of the toll-free telephone number is based on an amount of data transmitted through a geographic region associated with the primary carrier route compared to an amount of data expected to be transmitted through the geographic region.

18. The method of claim 14, wherein the determination of the predicted service interruption associated with the primary carrier route of the toll-free telephone number is based on an attribute of data transmitted along the primary carrier route compared to an expected attribute of data to be transmitted along the primary carrier route.

19. The method of claim 14, further comprising, responsive to a determination that the predicted service interruption associated with the primary carrier route of the toll-free telephone number has been resolved, communicating data to the service management system database to replace the determined alternative carrier route of the toll-free telephone number with the primary carrier route of the toll-free telephone number.

20. The method of claim 14, further comprising, responsive to the determination of the predicted service interruption associated with the primary carrier route of the toll-free telephone number, determining, by the processor, the alternative carrier route of the toll-free telephone number based on at least one of: a static routing parameter associated with a call source element, a static routing parameter associated with a destination element, and a routing parameter associated with the predicted service interruption.
